(19) United States
(12) Patent Application Publication
(10) Pub. No.: US 2017/0297916 A1
(43) Pub. Date: Oct. 19, 2017

(54) DISTILLATION PROCESS

(71) Applicant: SiTec GmbH, Augsburg (DE)

(72) Inventor: Mark William Dassel, Poulsbo, WA (US)

(73) Assignee: SiTec GmbH, Augsburg (DE)

(21) Appl. No.: 15/519,458

(22) PCT Filed: Oct. 14, 2015
(86) PCT No.: PCT/US15/55605

§ 371 Date: Jun. 1, 2017

Related U.S. Application Data
(60) Provisional application No. 62/063,913, filed on Oct. 14, 2014.
(60) Provisional application No. 62/075,774, filed on Nov. 5, 2014.

(51) Int. Cl. C01B 33/107; C01B 33/04; C01B 33/029; B01D 5/00; B01D 3/14

(52) U.S. Cl. CPC C01B 33/10773; C01B 33/10778; C01B 33/046; B01D 3/143; C01B 33/029; B01D 5/0063; C01B 33/043

(57) ABSTRACT

By incorporating an additional TCS and/or DCS redistribution reactor in the TCS recycle loop and/or DCS recycle loop, respectively, of a process and system for silane manufacture, efficiencies in the production of silane are realized. Further improvements in efficiencies may be realized by directing a portion of the product from a redistribution reactor into a distillation column, and specifically into the distillation column that formed the feedstock that went into the redistribution reactor.

### CROSS-REFERENCE TO RELATED APPLICATIONS

This application claims the benefit under 35 U.S.C. §119(e) of U.S. Provisional Patent Application No. 62/063,913 filed Oct. 14, 2014, and U.S. Provisional Patent Application No. 62/075,774 filed Nov. 5, 2014, which applications are incorporated herein by reference in its entireties.

### FIELD OF THE INVENTION

The present invention relates generally to chemical manufacture, more specifically to systems and processes for the distillative separation of chemical substances.

### BACKGROUND

Monosilane, which may be referred to herein simply as silane, and which has the chemical formula SiH₄, is used worldwide for a variety of industrial and commercial purposes including the production of flat-screen television screens, semiconductor chips, and polysilicon for conversion to solar cells. Due to its high purity, monosilane is emerging as the preferred intermediate for polysilicon production, where it competes with purified trichlorosilane which remains the dominant feedstock of choice due to lower overall polysilicon production costs. Further market inroads are contingent on reducing monosilane production costs—while maintaining its quality advantage, and on lowering conversion cost to polysilicon.

Most of the world's monosilane is produced using the so-called Union Carbide Process (“UCC process”), patented by the Union Carbide Corporation in 1977. In the UCC process, liquid chlorosilanes from a hydrochlorination unit are used by a monosilane production unit to make pure silane gas (SiH₄). This is achieved through a sequence of distillation and catalytic redistribution reactions converting TCS into ultra-pure SiH₄ and co-product STC. The co-product STC is returned to the hydrochlorination unit to be converted back to TCS.

The UCC process includes two redistribution reactors, which are used to convert TCS to SiH₄. The reactor catalyst consists of dimethlyamino groups chemically grafted to a styrene based support. The support is a macroreticular styrene-divinylbenzene copolymer. The redistribution of TCS to SiH₄ occurs through the progression of three reversible equilibrium reactions as shown:

1. 2 SiHCl₃(TCS) [symbol] SiH₂Cl₂(DCS)+SiCl₄(STC)

2. 2 SiH₂Cl₂(DCS) [symbol] SiHCl₃(TCS)+SiH₃Cl(MCS)

3. 2 SiH₃Cl(MCS) [symbol] SiH₂Cl₂(DCS)+SiH₄(Silane)

While it is convenient to consider the transformation from TCS to SiH4 as a series of these three separate reactions, in reality, all occur simultaneously in each reactor until equilibrium is achieved. Assuming that the reaction time is long enough to satisfy the reaction kinetics and equilibrium is achieved, the product composition within each reactor is determined mainly by the composition of the feed and secondarily by reaction temperature.

The redistribution reactor performing the first reaction is called the TCS reactor because it is designed to receive a pure TCS feedstock. With a pure TCS feedstock, the equilibrium of the three reactions is such that only reaction #1 progresses measurably in this reactor. The extent of reaction under these conditions is about 20%, with the reactor product being 80% of the unreacted TCS feed and 20% products: i.e., 10% DCS and 10% STC. Due to the low first pass conversion of TCS to DCS in this TCS reactor, distillation columns are used to separate the products, recovering the more hydrogenated chlorosilanes for recycle back the TCS reactor.

A first distillation column is used to both separate the STC from the TCS in the fresh chlorosilane feed stream and separate the STC in the product from the TCS reactor. A second distillation column is used to separate the DCS from TCS in the overhead product from the first distillation column. The bottom product from this second distillation column is essentially pure TCS and becomes the feed stock to the TCS redistribution reactor.

The DCS rich, TCS lean, product exiting the top of the second distillation column becomes the feed stock to the second redistribution reactor, called the DCS redistribution reactor (“DCS Reactor”). Due to the high DCS content in this feedstock, the equilibrium of the three reactions is such that only reactions #2 and #3 progress measurably in this reactor. The extent of reactions under these conditions is such that SiH₄, MCS, DCS and TCS are all present in the reactor product. SiH₄ composition in the DCS Reactor product is only 12-15 mole percent at equilibrium, and thus a third higher pressure column is used to separate and purify the SiH₄ from the MCS, DCS and TCS present in the DCS Reactor product. The MCS, DCS and TCS are then recycled back as a second feed to the second distillation column where the MCS and DCS are top products and feed the DCS Reactor. The TCS travels to the bottom of the second distillation column with the other TCS present in the feed stream from the first distillation column, thus increasing the amount of TCS in feed to the TCS Reactor.

In summary, a large TCS recycle loop with mass flow rate 30 times greater than that of the SiH₄ product mass flow rate must pass through the TCS Reactor to convert TCS in the fresh feedstock and TCS made as a by-product of SiH₄ production in the DCS Reactor to DCS. Once DCS is formed and separated from recycle TCS it becomes the feed to the DCS Reactor. A smaller DCS/MCS recycle loop whose mass flow rate is 10 times that of the SiH₄ product mass flow rate must flow through the DCS Reactor to convert DCS from the second distillation column and recycled DCS and MCS from the third distillation column into SiH₄.

To summarize, in the UCC process there are a total of two redistribution reactors. The first, which may be named the TCS Reactor, is located on the bottoms stream from the second distillation column. This stream is comprised almost entirely of TCS and contains de minimis amounts of DCS and STC, and is part of the TCS recycle loop. The second redistribution reactor, which may be named the DCS Reactor, is located on the overhead stream leaving the top of the second distillation column. This stream is substantially comprised of MCS and DCS, and is part of the DCS recycle loop. In normal operation, approximately 20% of TCS entering the TCS Reactor is converted to DCS and STC in roughly equal amounts, and approximately 45% to 50% of the DCS entering the DCS Reactor is converted to silane and TCS in roughly a 1:2 molar ratio.

Impurities in the crude feed stream, which comprise boron and phosphorus, are either absorbed by the redistribution catalyst, captured in filter elements, or leave with the co-product STC. The SiH₄ product is of exceptionally high purity with boron and phosphorus levels at the 5-10 pptw level.

Despite the commercial success of the UCC process, it is expensive to build, maintain and operate in large part due to the large mass flow rate through the TCS recycle loop, and to a lesser extent due to the large mass flow rate through the DCS recycle loop. The present disclosure provides improvements on the UCC process and related advantages as described herein.

### SUMMARY

In one aspect, the present disclosure provides a new distillation process. In one embodiment, the new distillation process includes: i) recovering a fraction from a distillation column, ii) subjecting that fraction (which will be referred to herein as the nondistributed fraction) to a redistribution reaction to thereby convert the nondistributed fraction to a redistributed fraction, and then iii) returning some portion of the redistributed fraction to the distillation column.

In one embodiment, the new distillation process replaces some or all of the reflux that typically returns to the distillation column with a chemically modified composition that is referred to herein as a redistributed composition. In one embodiment, the redistributed composition comprises a higher concentration of low boiling point components than does the typical reflux. Thus, one embodiment of the process of the present disclosure takes a fraction from the distillation column (referred to herein as a nondistributed composition) and converts one or more components of that fraction into at least one lower boiling point component, so as to provide a redistributed composition that in comparison to the nondistributed composition, contains a greater molar percentage of lower boiling point component(s). Some of this redistributed composition, or optionally all of this redistributed composition is then introduced into the distillation unit to provide some or all of the reflux that is necessary for the operation of the distillation column.

Accordingly, in one aspect the present disclosure provides a process comprising: recovering a fraction from a distillation column; subjecting that fraction, which will be referred to as the nondistributed fraction, to a redistribution reaction to thereby convert the nondistributed fraction to a redistributed fraction; and then returning a portion of the redistributed fraction to the distillation column. Optionally, any one or more of the following features may be used to further describe the process: the redistribution reaction comprises at least one of: trichlorosilane [symbol] dichlorosilane and silicon tetrachloride; dichlorosilane [symbol] trichlorosilane and monochlorosilane; and monochlorosilane [symbol] dichlorosilane and silane; the redistributed fraction comprises more dichlorosilane than does the nondistributed fraction; the redistributed fraction comprises more trichlorosilane than does the nondistributed fraction; the distillation column separates silicon tetrachloride from trichlorosilane; the distillation column separates trichlorosilane from dichlorosilane; the distillation column separates silicon tetrachloride from dichlorosilane; the distillation column separates dichlorosilane from monochlorosilane; the distillation column separates monochlorosilane from silane (SiH₄); up to 90 wt % or up to 80 wt % or up to 75 wt %, or up to 70 wt %, or up to 65 wt % or up to 60 wt %, or up to 55 wt %, or up to 50 wt %, or at least 20 wt %, or at least 40 wt %, or at least 50 wt %, or at least 55 wt %, or at least 60 wt %, or at least 65 wt %, or at least 70 wt %, or at least 75 wt %, e.g., 20-80 wt % or 40-75 wt %, or 50-75 wt % of the redistributed fraction is returned to the distillation column; the portion of the redistributed fraction which is returned to the distillation column provides a reflux to the distillation column; the process further comprises introducing another portion of the redistributed fraction into an additional distillation column; the process further comprises converting silane (SiH₄) to polysilicon.

When the present disclosure provides a process comprising recovering a fraction from a distillation column; subjecting that fraction (the nondistributed fraction) to a redistribution reaction to thereby convert the nondistributed fraction to a redistributed fraction; and then returning a portion of the redistributed fraction to the distillation column, this process may be applied to a variety of situations. For example, and referring to the Figures and Table 1, the distillation column may be distillation column (20) and the redistribution reactor is redistribution reactor (70), where the additional distillation column is distillation column (30). As another example, the distillation column may be distillation column (30) and the redistribution reactor is redistribution reactor (50), where the additional distillation column is distillation column (20). As yet another example, the distillation column may be distillation column (30) and the redistribution reactor is redistribution reactor (60), where the additional distillation column is distillation column (40). As a final example, the distillation column may be distillation column (40) and the redistribution reactor is redistribution reactor (80), where the additional distillation column is distillation column (30).

In another aspect the present disclosure provides a distillation process comprising:
a. providing a distillation unit capable of separating chemical substances on the basis of boiling point;
b. introducing a chemical mixture into the distillation column, where the chemical mixture comprises a first substance and a second substance that have different boiling points;
c. recovering at least a first fraction and a second fraction from the distillation column, where the first and second fractions differ from one another in terms of composition and boiling point;
d. providing a redistribution unit capable of converting a higher boiling substance into a lower boiling substance;
e. introducing a nondistributed composition into the redistribution unit, where the nondistributed composition is selected from the first and second fractions;
f. recovering a redistributed composition from the redistribution unit, where the redistributed composition has a higher molar concentration of a component of the nondistributed composition than does the nondistributed composition; and
g. introducing a portion of the redistributed composition into the distillation column.

In optional embodiments, any two or more of which may be combined to provide a more detailed description of the invention: the distillation unit is a distillation column; the chemical mixture comprises dichlorosilane (DCS) and trichlorosilane (TCS), where DCS is the first substances and TCS is the second substance; the chemical mixture is introduced by introducing a single composition that comprises both the first and the second substances into the distillation unit; the chemical mixture is introduced by separately introducing the first substance and the second substance into the distillation unit; the chemical mixture includes a third substance; the third substance is silicon tetrachloride (STC); the first and second substances different by at least 10° C. in boiling point, or at least 15° C. in boiling point, or at least 20° C. in boiling point, or by not more than 30° C. in boiling point; the first fraction comprises a mixture of first and second substances, the first fraction has a lower boiling point than does the second fraction; the first and second fraction both contain DCS and TCS, however the first fraction contains a greater molar concentration of DCS than does the second fraction (coming out of the distillation column, the second fraction may have no DCS) ; the first fraction contains a lower molar concentration of STC than does the second fraction; the redistribution unit contains catalyst selected from tertiary amine, quaternary amine and Lewis acid; the redistribution unit converts TCS into a mixture comprising DCS and optionally comprising STC; the first fraction serves as the nondistributed composition and is introduced into the redistribution unit; the redistributed composition contains a higher molar concentration of DCS than does the nondistributed composition; the redistributed composition contains a higher molar concentration of STC than does the nondistributed composition; redistributed composition is the only reflux entering the distillation unit.

The present disclosure also provides systems. For example, in one embodiment, the present disclosure provides a system comprising: a distillation column; a redistribution reactor; a conduit that directs a fraction from the distillation column into the redistribution reactor; and a conduit that directs a portion of a product from the redistribution reactor back into the distillation column. Optionally, any one or more of the following features may be used to further describe the system: the system further comprises another distillation column; the system further comprises another redistribution reactor; the system further comprises a reactor to convert SiH₄ to polysilicon.

In one embodiment, the systems as disclosed herein and the processes as disclosed herein may be performed in combination with polysilicon manufacture. For example, the systems as disclosed herein may include a reactor, e.g., a CVD reactor or a fluidized bed reactor, wherein polysilicon is produced. As another example, the processes as disclosed herein may include the production of polysilicon from silane or from trichlorosilane.

The details of one or more embodiments are set forth in the description below. The features illustrated or described in connection with one exemplary embodiment may be combined with the features of other embodiments. Other features, objects and advantages will be apparent from the description, the drawings, and the claims. In addition, the disclosures of all patents and patent applications referenced herein are incorporated by reference in their entirety.

### BRIEF DESCRIPTION OF THE DRAWINGS

Features of the present disclosure, its nature and various advantages will be apparent from the accompanying drawings and the following detailed description of various embodiments.

FIG. 1A is a schematic block diagram of a system and process of the present disclosure for the production of silane comprising three distillation columns, two redistribution reactors on the TCS recycle loop and two redistribution reactors on the DCS recycle loop. The system and process of the present disclosure includes conduit (not shown) to provide product that comes from a redistribution reactor to be delivered into the distillation column which produced the feedstock for the redistribution reactor.

FIG. 1B is a schematic block diagram of a system and process of the present disclosure to be understood by reference to FIG. 1A, where FIG. 1B shows how effluent (stream 4) from a representative redistribution reactor (70) can be used as reflux and/or feedstock to the distillation column (20) that provided the feedstock to the representative redistribution reactor (70).

FIG. 1C is a schematic block diagram of a system and process of the present disclosure to be understood by reference to FIG. 1A, where FIG. 1C shows how effluent (stream 6) from a representative redistribution reactor (50) can be used as a feedstock to the distillation column (30) that provided the feedstock to the representative redistribution reactor (50).

FIG. 2 is a schematic block diagram of a system and process of the present disclosure for the production of silane comprising three distillation columns, two redistribution reactors on the TCS recycle loop and one redistribution reactor on the DCS recycle loop. The system and process of the present disclosure includes conduit (not shown) to provide product that comes from a redistribution reactor to be delivered into the distillation column which produced the feedstock for the redistribution reactor.

FIG. 3 is a schematic block diagram of a system and process of the present disclosure for the production of silane comprising three distillation columns, one redistribution reactor on the TCS recycle loop and two redistribution reactors on the DCS recycle loop. The system and process of the present disclosure includes conduit (not shown) to provide product that comes from a redistribution reactor to be delivered into the distillation column which produced the feedstock for the redistribution reactor.

FIG. 4 is a schematic block diagram of a system and process for the production of silane that comprises one redistribution reactor on the TCS recycle loop and one redistribution reactor on the DCS recycle loop. The system and process of the present disclosure includes conduit (not shown) to provide product that comes from a redistribution reactor to be delivered into the distillation column which produced the feedstock for the redistribution reactor.

FIG. 5 is a graph which illustrates change in energy savings as a function of variation in the amount of redistribution reactor effluent which is used to provide reflux to a distillation column, and where the term “Total Reboiler Energy Duty” refers to the total energy used in all the reboilers in the three (3) distillation column systems 20, 30 and 40 depicted in FIG. 2.

Corresponding reference numerals indicate corresponding parts throughout the drawings. The detailed description of the present disclosure makes reference to various chemical streams that are generated and consumed. These streams are identified as stream 1, stream 2, etc. For the convenience of the reader, in the Figures, the reference S1 is placed next to the conduit that carries stream 1, the reference S2 is placed next to the conduit that carries stream 2, etc. The reference numbers used in the drawings and the name used herein for the corresponding part are provided in Table 1.

TABLE 1

| Ref. No. | Part Name |
|---|---|
| S1 | Stream 1 |
| 10 | Source for Stream 1 |
| 11 | Conduit for Stream 1 |
| 20 | First Distillation Column |
| S2 | Stream 2 |
| 21 | Conduit for Stream 2 |
| S3 | Stream 3 |
| 22 | Conduit for Stream 3 |
| 23 | Mixing Valve |
| 24 | Condenser |
| 24a | Conduit |
| 26 | Tank |
| 26a | Conduit |
| 28 | Pump |
| S12 | Stream 12 |
| 28a | Conduit for Stream 12 |
| S13 | Stream 13 |
| 28b | Conduit for Stream 13 |
| 30 | Second Distillation Column |
| S5 | Stream 5 |
| 31 | Conduit for Stream 5 |
| S7 | Stream 7 |
| 32 | Conduit for Stream 7 |
| 40 | Third Distillation Column |
| S9 | Stream 9 |
| 41 | Conduit for Stream 9 |
| S10 | Stream 10 |
| 42 | Conduit for Stream 10 |
| 50 | First TCS Redistribution Reactor |
| S6 | Stream 6 |
| 51 | Conduit for Stream 6 |
| 52 | Diverter valve |
| S16 | Stream 16 |
| 53 | Conduit for Stream 16 |
| 60 | First DCS Redistribution Reactor |
| S8 | Stream 8 |
| 61 | Conduit for Stream 8 |
| 70 | Second TCS Redistribution Reactor |
| S4 | Stream 4 |
| 71 | Conduit for Stream 4 |
| 72 | Diverter valve |
| S14 | Stream 14 |
| 73 | Conduit for Stream 14 |
| 74 | Diverter valve |
| S15 | Stream 15 |
| 75 | Conduit for Stream 15 |
| 80 | Second DCS Redistribution Reactor |
| S11 | Stream 11 |
| 81 | Conduit for Stream 11 |
| 85, 86 | Conduits |
| 87 | Mixing Valve |
| 88 | Conduit |
| 89 | Quenching Chamber |
| 90, 91, 92 | Conduits |
| 93 | Hydrogenation Reactor |
| 94, 95, 96, | Conduits |
| 97 | Column |
| 98, 99 | Conduits |
| 100 | Storage Tank |

### DETAILED DESCRIPTION OF THE INVENTION

The present disclosure provides systems and processes that are useful in chemical manufacturing, and more specifically in those situations where a distillation process provides a fraction that is subjected to a redistribution reaction. In these situations, the present disclosure provides that some of the effluent from the redistribution reactor is returned to the distillation column. The systems and processes as described herein are useful, for example, in silane manufacturing, where the silane so generated may optionally be used in the manufacture of polysilicon by the UCC process.

The systems and methods of the present disclosure are particularly useful in combination with a modified UCC process as disclosed in U.S. Patent Application No. 61/819572 filed May 4, 2013; and PCT Patent Application No. U52014/36711 filed May 3, 2014, both of which are incorporated herein by reference for all purposes.

Various conventions as used herein will be described for the convenience of the reader. The term STC will be used to designate silicon tetrachloride (SiCl₄); TCS will designate trichlorosilane (HSiCl₃); DCS will designate dichlorosilane (H₂SiCl₂); MCS will designate monochlorosilane (H₃SiCl) and silane will designate SiH₄.

In describing the systems and processes of the present disclosure comprising various recited features, the term “a” will have its usual meaning of “one or more” or “at least one” of the stated features. For example, a distillation column which receives a feedstock may optionally receive one and only one feedstock or it may optionally receive a plurality of feedstocks. The terms “a”, “one or more” and “at least one” are used interchangeably herein. Likewise, when a distillation column is said to provide a fraction, it should be understood that the distillation column may actually provide a plurality of fractions, so long as it provides at least one fraction.

As mentioned previously, in one aspect, the present disclosure provides a new distillation process. In one embodiment, the new distillation process includes: i) recovering a fraction from a distillation column, ii) subjecting that fraction (which will be referred to herein as the nondistributed fraction) to a redistribution reaction to thereby convert the nondistributed fraction to a redistributed fraction, and then iii) returning some portion of the redistributed fraction to the distillation column.

In general, distillation columns are well known and are utilized in a large number of chemical manufacturing plants. Thus, the following discussion will be brief and at a high level. Basically, a distillation column receives a mixture of chemicals and then separates those chemicals into fractions based on the differences in boiling points of the components of the mixture. The distillation column often takes the form of a cylindrical column standing upright, and may sometimes be referred to as a distillation tower. Heat is applied to the bottom of the column so that the bottom of the column is hotter than the top of the column.

The distillation process may be a continuous distillation process or a batch distillation process. In continuous distillation, one or more feedstocks are constantly being fed into the column, while at the same time one or more separated fractions are constantly being withdrawn. In batch distillation, a mixture is added to the (optionally at ambient temperature) column and then the column is heated to vaporize the various components of the mixture and allow fractions to be formed and withdrawn from the column.

In a continuous distillation process, one or more feedstocks enter the column, typically although certainly not always towards the middle of the column. When there are multiple feedstocks it is sometimes advantageous to have the feedstocks enter the column at different distances from the bottom of the column, depending on the composition of the feedstock. The one or more feedstocks ultimately introduce a mixture of chemical substances into the distillation column, and those substances will travel higher or lower in the column depending on their respective boiling points. Substances with relatively low boiling points will travel relatively higher in the column than will substances with relatively high boiling points. The various vaporized substances may collectively or individually be referred to as distillate.

In order to achieve efficient separation, the column is typically fitted or packed with some material. For example, horizontal plates or trays may be spaced along the distillation column. An example of a typical packing material is Raschig rings.

The distillation column will contain one or more exit ports where distillate may be withdrawn from the column. Each exit port is used to collect a fraction of the mixture, where each fraction will be characterized by the average boiling point of the components of the mixture. Low boiling point materials are collected at a relatively high point in the column, and the collected fraction may be referred to as a low boiling fraction. High boiling point materials are collected at a relatively low point in the column, and the collected fraction may be referred to a high boiling point fraction.

The composition of a collected fraction is different from the composition of the mixture that is introduced into the distillation column. The collected fraction will be different in terms of composition by having more or less of at least one of the components that are present in the mixture. In other words, a listing of the concentrations of the components of the collected fraction will be different from a listing of the concentrations of the components of the mixture that is introduced into the distillation column.

After the components of the mixture have become wholly or partially separated within the column, one or more fractions are withdrawn from the column. The present invention selects at least one of those fractions, and refers to the selected fraction as the nondistributed fraction. The nondistributed fraction is introduced into a redistribution reactor, whereupon it undergoes a redistribution reaction as described elsewhere herein. The redistribution reaction causes one or more components of the nondistributed fraction to undergo a chemical change, so that the effluent from the redistribution reactor is different in terms of composition compared to the composition of the nondistributed fraction. The effluent is referred to as the redistributed fraction.

The difference in composition between the nondistributed fraction and the redistributed fraction may be in terms of the relative amounts of the various components of the nondistributed fraction. Alternatively, or additionally, the difference in composition between the nondistributed fraction and the redistributed fraction may be in terms of new chemical entities that are present in the redistributed fraction but are not present in the nondistributed fraction. Similarly, the difference in composition between the nondistributed fraction and the redistributed fraction may be in terms of the absence of one or more chemical entities that were present in the nondistributed fraction but are missing in the redistributed fraction. Overall, a listing of the components of the nondistributed fraction will be different from a listing of the components of the redistributed fraction.

Although the redistributed fraction is referred to as a “fraction”, in fact the redistribution reactor preferably produces only a single effluent, i.e., a single fraction. Thus, all of the material that is subjected to redistribution is collected in a single stream from the redistribution reactor.

The present disclosure provides that some of the redistributed fraction is returned to the distillation column. The present disclosure thus provides a loop: feedstock(s) enter the distillation column, an exiting fraction from the distillation column is selected and introduced into a redistribution reactor, the product from the redistribution reactor is collected and a portion thereof is introduced into the distillation column. The processes and systems of the present disclosure, which include this loop, have advantages relative to the corresponding systems and processes without the loop, particularly in terms of energy savings.

For example, in one embodiment the present disclosure provides a process comprising: introducing a feedstock into a distillation column to provide a mixture to be separated within the distillation column; collecting a fraction from the distillation column; introducing the fraction into a redistribution reactor to provide a redistributed fraction; collecting the redistributed fraction and directing a portion thereof into the distillation column.

Optionally, any one or two or more of the following descriptors may be used to further define the inventive process: the feedstock comprises at least two of silane, monochlorosilane, dichlorosilane, trichlorosilane and silicon tetrachloride; withdrawing a fraction from the distillation column, where the fraction has a different composition compared to the mixture that is introduced into the column and is referred to as a nondistributed fraction; introducing the nondistributed fraction into a redistribution reactor so as to provide a redistributed fraction; the redistributed fraction comprises at least two of silane, monochlorosilane, dichlorosilane, trichlorosilane and silicon tetrachloride; the nondistributed fraction may be collected from the top of the column, where such a nondistributed fraction would (had it not been collected) function as a reflux stream for the column.

The redistributed fraction may be introduced into various places of the distillation column. For example, the redistributed fraction may be used to supplement, or optionally entirely replace, a reflux stream to the distillation column. In one embodiment, the distillation column has a reflux stream at the top of the column which comprises the lowest boiling materials in the mixture. In a standard manner of operating a distillation column, this reflux stream is returned to the column in order to improve efficiency of separation. According to the present disclosure, the reflux stream of a column is collected as the nondistributed fraction, it is converted into a redistributed fraction within a redistribution reactor, and at least some of the redistributed fraction is used as the reflux stream for the column.

While in one embodiment a portion of the redistributed fraction is introduced at or near the top of the column and so functions as a reflux stream for the column, in another embodiment a portion of the redistributed fraction is introduced below the top or near-the top of the distillation column, and effectively functions as an additional feedstock to the distillation column.

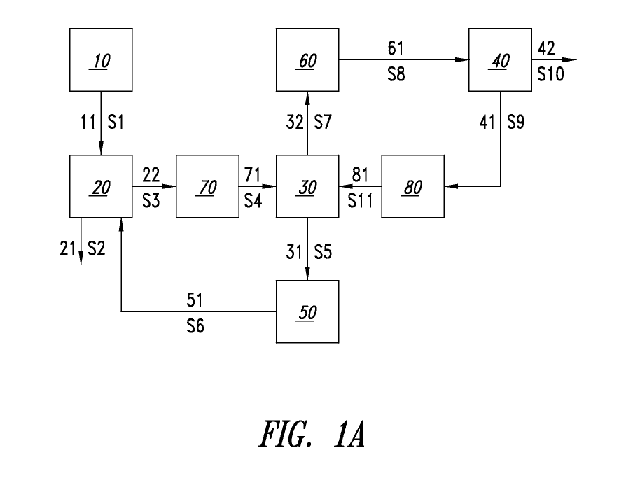

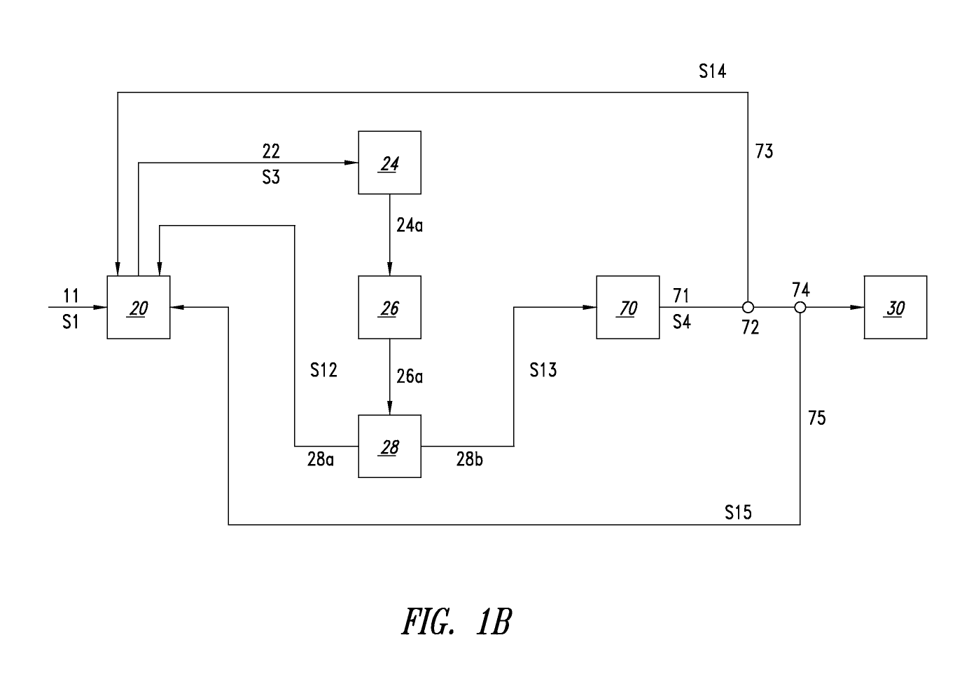

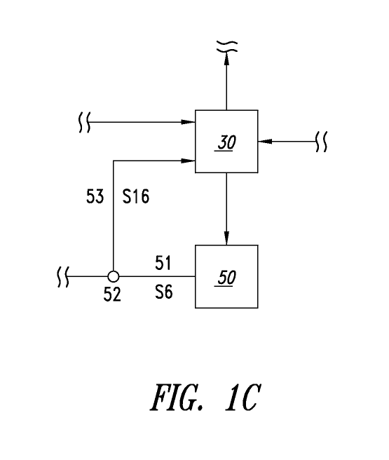

In one embodiment, the system of the present disclosure comprises first, second and third distillation columns which are identified in the FIGS. 1-3 as 20, 30 and 40, respectively. In addition, the system comprises at least one TCS redistribution reactor, designated as 50 in FIGS. 1-3, and at least one DCS redistribution reactor, designated as 60 in FIGS. 1-3. For convenience, the TCS redistribution reactor (TCS-RR) 50 will be referred to as the first TCS-RR 50, and the DCS redistribution reactor (DCS-RR) 60 will be referred to as the first DCS-RR 60. In addition, the system comprises one or both of a second TCS-RR 70 and a second DCS-RR 80. In addition, although not shown in the Figures, the system comprises conduit which is used to deliver a portion of a redistributed fraction to that distillation column which provided the nondistributed fraction that will, after it passes through the redistribution reactor, become the redistributed fraction. Optionally, the system may comprise a reactor for polysilicon production.

An embodiment of the process and system of the present disclosure is illustrated in FIG. 1A. In FIG. 1A, the first distillation column 20 receives stream 1 via conduit 11 from a source 10, the stream 1 comprising DCS, TCS and STC. The source 10 will be discussed later herein, but may be, for example, an off-gas of a hydrogenation reactor that produces unrefined TCS. First distillation column 20 forms and provides relatively high boiling stream 2 which comprises STC, and relatively low boiling stream 3 which comprises DCS and TCS. Stream 2 exits column 20 via conduit 21, while stream 3 exits column 20 via conduit 22. The STC in stream 2 may be recycled to a hydrogenation reactor in the front end of the plant, as discussed later herein.

The embodiment of FIG. 1A also comprises a second distillation column 30. The column 30 receives two streams, identified in FIG. 1A as stream 4 and stream 11. Stream 4 comprises DCS, TCS and STC, and enters distillation column 30 via conduit 71, while stream 11 comprises silane, MCS, DCS and TCS, and enters column 30 via conduit 81. In addition, second distillation column 30 generates two streams, identified in FIG. 1A as stream 5 and stream 7. Stream 5 comprises relatively high boiling TCS and STC, and exits column 30 via conduit 31. Stream 7 comprises relatively low boiling silane, MCS and DCS, and exits column 30 via conduit 32.

In addition, the embodiment of FIG. 1A comprises a third distillation column 40. The column 40 receives a stream 8 via conduit 61, where stream 8 comprises silane, MCS, DCS and TCS. Column 40 generates two streams, namely stream 9 and stream 10. Stream 9 comprises relatively high boiling MCS, DCS and TCS, while stream 10 comprises relatively low boiling but highly pure silane. Stream 9 exits column 40 via conduit 41, while stream 10 exits column 40 via conduit 42.

In addition to the three distillation columns 20, 30 and 40, the embodiment of FIG. 1A comprises four redistribution reactors 50, 60, 70 and 80. The units 20, 30, 50 and 70 and/or streams S3, S4, S5 and S6 in FIG. 1A comprise what will be referred to as the TCS recycle loop. The units 30, 40, 60 and 80 and/or streams S7, S8, S9 and S11 comprise what will be referred to as the DCS recycle loop.

As used herein, a redistribution reactor for a polysilicon plant receives one or more feedstock streams (which may be referred herein to as nondistributed streams or nondistributed fractions) and converts that feedstock(s) into an effluent stream (which may be referred to herein as a redistributed stream or a redistributed fraction) according to the following three equilibrium reactions.

2SiHCl₃(TCS) [symbol] SiH₂Cl₂(DCS)+SiCl₄(STC) (a)

2SiH₂Cl₂(DCS) [symbol] SiHCl₃(TCS)+SiH₃Cl(MCS) (b)

2SiH₃Cl(MCS) [symbol] SiH₂Cl₂(DCS)+SiH₄(Silane) (c)

For clarification, it will be mentioned that the symbol “ [symbol] ” denotes an equilibrium reaction, wherein reactants and products interconvert under the reaction conditions provided by the redistribution reactor. For example, a single composition may be directed into the redistribution reactor, where this single composition contains both dichlorosilane and silicon tetrachloride. The redistribution reactor is operated under redistribution conditions, so that a redistribution reaction occurs between the dichlorosilane and the silicon tetrachloride, and trichlorosilane is thereby produced, according to reaction “(a)” shown above. Thus, in one embodiment as denoted by reaction (a), TCS or a mixture of DCS and STC is introduced into a redistribution reactor, and a redistribution reaction takes place therein, so that a redistributed fraction being a mixture of TCS, DCS and STC results. In another embodiment as denoted by reaction (b), DCS or a mixture of TCS and MCS is introduced into a redistribution reactor, and a redistribution reaction takes place therein, so that a redistributed fraction being a mixture of DCS, TCS and MCS results. In another embodiment as denoted by reaction (c), MCS or a mixture of DCS and silane is introduced into a redistribution reactor, and a redistribution reaction takes place therein, so that a redistributed fraction being a mixture of MCS, DCS and silane results.

A catalyst may be present in the redistribution reactor, e.g., a combination of tertiary amine and tertiary amine salt as disclosed in, e.g., U.S. Pat. No. 4,610,858. As disclosed in U.S. Pat. No. 4,610,858, the combination of tertiary amine and tertiary amine salt is used to perform a disproportionation reaction, which is an equilibrium reaction whereby TCS may be converted to silane (SiH₄) and STC. The redistribution reaction of the present disclosure may utilize the same catalyst and operating conditions of temperature and pressure as disclosed in U.S. Pat. No. 4,610,858. As an alternative, the redistribution catalyst may be obtained from Langxess (Cologne, Germany) as their products Lewatit™ S 4268 or Lewatit™ MP 62, where Langxess may refer to these products as dismutation catalysts. Another suitable catalyst is an ion exchange resin including but not limited to Rohm & Haas Amberlyst™-21 (A-21) catalyst (now sold by Dow Chemical, Midland, Mich., USA) which is a weak base tertiary methyl amine supported on a polystyrene/divinyl benzene bead. A fixed bed or fluid bed reactor may be employed in the redistribution reactor.

The TCS recycle loop comprises two redistribution reactors that receive TCS, and these will be referred to as the first TCS-RR 50 and the second TCS-RR 70. In the TCS recycle loop, stream 3 comprising DCS and TCS from the distillation column 20 is introduced into the second TCS-RR 70. TCS-RR 70 converts a portion of the TCS in stream 3 into DCS and STC, thereby generating stream 4 which comprises DCS, TCS, and STC, where the DCS and STC content in stream 4 are greater than that introduced into TCS-RR 70 via steam 3 and the TCS content is lower than that introduced into TCS-RR 70 via steam 3. Stream 4 exits TCS-RR 70 via conduit 71. Stream 4 is then introduced into distillation column 30 as discussed previously, and stream 5 exits distillation column 30 via conduit 31. As previously noted, all or a portion of stream 4 may be directed to distillation column 20 for use as reflux. The contents of stream 5 enter the first TCS-RR 50. In TCS-RR 50, the TCS and STC of stream 5 undergo an equilibrium reaction so as to generate stream 6 which comprises DCS in addition to the TCS and STC that were present in stream 5. Stream 6 is introduced into distillation column 20, where stream 6 is separated into relatively high boiling stream 2 comprising STC and relatively low boiling stream 3 comprising DCS and TCS.

Optionally, the feedstock to the first TCS-RR may be characterized in terms of the relative amounts of chloride and silicon present in the feedstock. In various embodiments, the feedstock to the first TCS-RR has a ratio of chloride to silicon atoms in the range of 4:1 to 1:1, or in the range of 3.5:1 to 2:1, or in the range of 3.5:1 to 2.5:1. Likewise, the feedstock to the second TCS-RR may be characterized by the same ratio. In various embodiments, the feedstock to the second TCS-RR has a ratio of chloride to silicon atoms in the range of 4:1 to 1:1, or in the range of 3.5:1 to 2:1, or in the range of 3.5:1 to 2.5:1. Optionally, the ratio of chloride to silicon atoms in the feedstock to the first TCS-RR is greater than the ratio of chloride to silicon atoms in the feedstock to the second TCS-RR. For example, the ratio of chloride to silicon atoms in the feedstock to the first TCS-RR may be in the range of 4:1 to 2.7:1 while the ratio of chloride to silicon atoms in the feedstock to the second TCS-RR is a lower value that may be in the range of 3.5:1 to 2.5:1.

The DCS recycle loop likewise comprises two redistribution reactors that receive DCS, and these will be referred to as the first DCS-RR 60 and the second DCS-RR 80. In the DCS recycle loop, stream 7 comprising silane, MCS and DCS from the distillation column 20 is introduced via conduit 32 to the first DCS-RR 60. DCS-RR 60 converts a portion of the DCS in stream 7 into silane and TCS, thereby generating stream 8 which comprises silane, MCS, DCS, and TCS, where the silane and TCS content in stream 8 are greater than that introduced into DCS-RR 60 via steam 7 and the DCS content is lower than that introduced into DCS-RR 60 via steam 7. Stream 8 exits DCS-RR 60 via conduit 61. Stream 8 is introduced into the third distillation column 40 to generate a stream 9 comprising MCS, DCS and TCS, and a stream 10 comprising largely pure silane. The stream 9 is directed via conduit 41 to a second DCS-RR 80, which converts the mixture of MCS, DCS and TCS in stream 9 to a mixture of silane, MCS, DCS and TCS which exits second DCS-RR 80 via conduit 81 as stream 11. Stream 11 is introduced into the second distillation column 30 as discussed above, to generate streams 5 and 7.

Optionally, the feedstock to the first DCS-RR may be characterized in terms of the relative amounts of chloride and silicon present in the feedstock. In various embodiments, the feedstock to the first DCS-RR has a ratio of chloride to silicon atoms in the range of 4:1 to 1:1, or in the range of 3:1 to 1:1, or in the range of 2.5:1 to 1:1. Likewise, the feedstock to the second DCS-RR may be characterized by the same ratio. In various embodiments, the feedstock to the second DCS-RR has a ratio of chloride to silicon atoms in the range of 4:1 to 1:1, or in the range of 3.5:1 to 1:1. Optionally, the ratio of chloride to silicon atoms in the feedstock to the second DCS-RR is greater than the ratio of chloride to silicon atoms in the feedstock to the first DCS-RR. For example, the ratio of chloride to silicon atoms in the feedstock to the first DCS-RR may be in the range of 2:1 to 1:1 while the ratio of chloride to silicon atoms in the feedstock to the second DCS-RR is a higher value that may be in the range of 3:1 to 1.5:1.

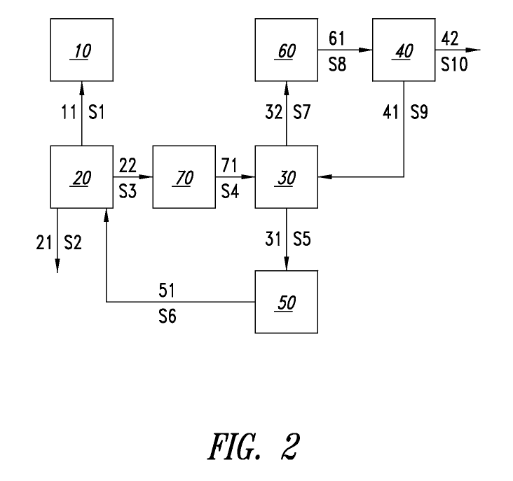

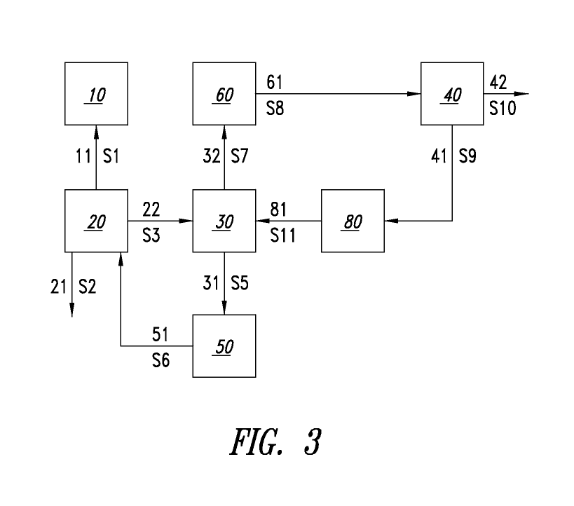

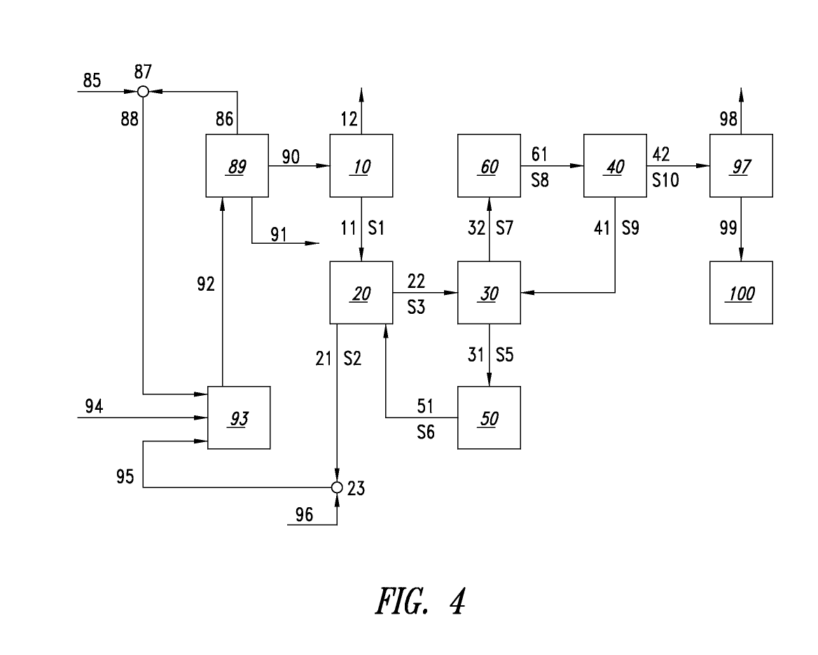

In the system shown in FIG. 1A, any one or more of the redistribution reactors 50, 60, 70 and 80 may incorporate a reactor filter, where the reactor filter will catch fine particles of, for example, 5 microns or smaller from becoming entrapped in the reactor. The ion exchange resin used in a redistribution reactor also functions as a deep bed filtration device trapping fine particles that enter or are formed in the redistribution reactor. These particles may be, e.g., silicates, boron-silicates, metal chlorides and small bits of ion exchange resin. Over time these particles build up causing high pressure drop across the reactor. One option to address this problem is to periodically reverse the flow through the reactor (a flow that is originally bottom up is changed to top down) in order to flush out these fine particles. However, during this backflow operation the fine particles are released downstream leading to potential contamination problems. One option for reducing the problem of fine particles is to install feed or outlet filters on the reactors, preferably outlet filters, which will catch these fine particles. This approach will substantially reduce the contamination risk associated with periodically backflushing the reactor. The reactor filter must periodically be replaced or cleaned, or else it will become plugged and cause increased pressure within the reactor. Likewise, the systems illustrated in any of FIG. 2, FIG. 3 and FIG. 4 may incorporate redistribution reactors that include a reactor filter.

The systems and process of the present disclosure provide that a portion of the product from a redistribution reactor is introduced into the distillation column that provided the feedstock for the redistribution reactor. This feature is not explicitly shown in FIG. 1A, however is illustrated in FIG. 1B and FIG. 1C, where FIG. 1B and FIG. 1C may be understood in conjunction with any of FIGS. 1A, 2, 3 or 4. In effect, the present disclosure as illustrated by FIG. 1B and FIG. 1C provides for some fraction of the effluent from a redistribution reactor to be directed (recycled back) into the distillation column that generated the feedstock for the redistribution reactor. This method may be referred to herein as recycling. Recycling may substitute as an alternative reflux for the traditional reflux (for example, stream 12 in FIG. 1B) formed from a distillation column, and/or may introduce additional feedstock to the distillation column which will be subjected to distillative fractionation. By following the methods and utilizing the systems illustrated in FIG. 1B and FIG. 1C, and applying the principles illustrated therein to the systems and methods illustrated in each of FIGS. 1A, 2, 3 and/or 4, there is achieved an increase in the conversion of TCS to DCS and/or DCS to silane per pass through the TCS recycle loop and/or the DCS recycle loop, respectively, as well as other benefits as described herein.

In FIG. 1B, stream 4 leaves redistribution reactor 70 via conduit 71. Optionally, stream 4 passes through diverter valve 72 and then a fraction of stream 4 may travel through conduit 73 into distillation column 20 such that some fraction of stream 4, which is less than 100% of stream 4, provides the reflux to the top of the distillation column 20. This stream will be referred to for convenience as stream 14, although compositionally it is the same as stream 4. Optionally, stream 4 passes through diverter valve 74 and then a fraction of stream 4 may travel through conduit 75 into distillation column 20, such that some fraction of stream 4, which is less than 100% of stream 4, provide an additional feedstock to the distillation column 20. This stream will be referred to for convenience as stream 15, although compositionally it is the same as stream 4. Stream 15 provides additional feedstock to column 20, i.e., feedstock in addition to that provided by stream 1 which enters column 20 by way of conduit 11. What fraction of stream 4 which does not enter either of conduit 73 or conduit 75 will remain in conduit 71 and enter distillation column 30. Accordingly, the volume of stream 4 which leaves the redistribution reactor 70 may be reduced prior to stream 4 entering the distillation column 30, where the reduction in volume occurs because some fraction of stream 4 is diverted into conduit 73 and/or 75 to form stream 14 and/or stream 15, respectively.

In the event that a fraction of stream 4 should provide some or all of the reflux to distillation column 20, it will be necessary to remove some or all of the traditional reflux from column 20. In traditional practice, a portion of the overhead distillate leaving a distillation column is refluxed directly back to the top of the column, to provide what will be referred to herein as traditional reflux. According to one embodiment of the present disclosure, some or all of the overhead distillate that is generated in distillation column 20 is removed before it can reflux back into the column, and a different reflux composition is substituted for the traditional reflux of the column. This replacement of traditional reflux for an alternative reflux may be accomplished as shown in FIG. 1B.

Thus, returning to FIG. 1B, it is seen that the overhead distillate stream 3 exits distillation column 20 via conduit 22 and is taken to a separate condenser unit 24. The overhead stream 3 is cooled in the condenser 24 and then passes as a liquid through conduit 24a whereupon it enters a storage tank 26. When the liquified stream 3 as present in tank 26 is needed, it may exit the storage tank 26 via conduit 26a and enter a pump 28. From the pump 28, some or all of the liquefied stream 3 may be directed through conduit 28a and then into the top of distillation column 20, where it may provide some or all of the traditional reflux for the column 20. In essence, stream 12 is the same composition as would be formed in a condenser located on top of distillation column 20, where the condenser would cool and condense the overhead distillate and thereby provide what is referred to herein as the traditional reflux to column 20. In this capacity as a traditional reflux, a portion of stream 3 will be referred to as stream 12. In addition, some portion of stream 3 may exit the pump 28 through conduit 28b and then enter the redistribution reactor 70. In this capacity, stream 3 will be referred to as stream 13. In one embodiment, 60-80% of stream 3 becomes reflux stream 12 for distillation unit 20, and the remainder of stream 3, i.e., 20-40% of stream 3, becomes feedstock stream 13 for redistribution reactor 70. In one embodiment, stream 12 has a zero flow rate. Thus, in one embodiment where stream 12 has a zero flow rate, all reflux on distillation column 20 is via stream 14 which derives from stream 4. Similarly for an analogous process that utilizes distillation column 30 and DCS redistribution reactor 60.

In FIG. 1C, stream 6 leaves redistribution reactor 50 via conduit 51 and a portion of stream 6 is introduced into distillation column 30. Thus, stream 6 passes through diverter valve 52 such that some fraction of stream 6 is diverted into conduit 53 whereupon it travels into distillation column 30. According to FIG. 1C, some fraction of stream 6, which is less than 100% of stream 6, provides additional feedstock to distillation column 30. This stream will be referred to for convenience as stream 16, although compositionally it is the same as stream 6. What fraction of stream 6 which does not enter into conduit 53 will remain in conduit 51 and enter distillation column 20.

It should be understood that the present disclosure provides the system and method illustrated by reference to FIG. 1A, wherein either one or both of the systems and methods illustrated in FIG. 1B and FIG. 1C have been incorporated. For example, in one embodiment the present disclosure provides the system and method illustrated by reference to FIG. 1A which incorporates the features of FIG. 1B but not the features of FIG. 1C. In another embodiment, the present disclosure provides the system and method illustrated by reference to FIG. 1A which incorporates the feature of FIG. 1C but not the features of FIG. 1B. In another embodiment, the present disclosure provides the system and method illustrated by reference to FIG. 1A which incorporates the features of FIG. 1B and the features of FIG. 1C. In each of these embodiments which incorporate the features of FIG. 1B, it is optionally provided that i) the system and method of the present disclosure includes diverter valve 72 but not diverter valve 74 such that some portion of stream 4 is used as reflux to the distillation column 20 but no portion of stream 4 is used as additional feedstock to distillation column 20; ii) the system and method of the present disclosure includes diverter valve 74 but not diverter valve 72 such that some portion of stream 4 is used as additional feedstock to the distillation column 20 but no portion of stream 4 is used as the reflux for distillation column 20; and iii) the system and method of the present disclosure includes diverter valve 74 and also includes diverter valve 72 such that some portion of stream 4 is used as additional feedstock to the distillation column 20 but some portion of stream 4 is used as the reflux for distillation column 20.

As mentioned previously, the present disclosure provides that a portion of the effluent from a redistribution reactor is directed back into the distillation column which provided the feedstock to the redistribution reactor, where that effluent portion may provide one or both of reflux to the distillation column and additional feedstock to the distillation column. It should be mentioned that when the present disclosure indicates that a portion of the effluent from a redistribution reactor is introduced into the distillation column which provided the feedstock to the redistribution reactor, it should be understood (unless specified to the contrary) that this effluent is unmodified in terms of composition between leaving the redistribution reactor and entering the distillation column. For example, the effluent is not subjected to a distillation process between when it exits the redistribution reactor and it enters the distillation column.

In the context of FIGS. 1A, 1B, 1C and 2-4, this situation may arise when distillation column 20 provides the feedstock to redistribution reactor 70, as discussed in detail above with reference to FIG. 1B and FIG. 1C. By analogy, the following additional embodiments are also provided. In one embodiment, a portion of stream 6 is introduced into distillation column 30, where stream 6 provides an additional feedstock to distillation column 30. In one embodiment, a portion of stream 8 is introduced into distillation column 30. Optionally, stream 8 provides the reflux to the top of the distillation column 30. Optionally, stream 8 provides an additional feedstock to the distillation column 30. In one embodiment, a portion of stream 11 is introduced into distillation column 40.

The embodiment of the present disclosure shown in FIG. 1A provides for two TCS-RRs on the TCS recycle loop and two DCS-RRs on the DCS recycle loop. In alternative embodiments, the present disclosure provides a system and process having two TCS-RRs on the TCS recycle loop but only a single DCS-RR on the DCS recycle loop, as illustrated in FIG. 2, and a system and process having two DCS-RRs on the DCS recycle loop but only a single TCS-RR on the TCS recycle loop, as illustrated in FIG. 3. The embodiments illustrated in FIGS. 2 and 3 will now be described in more detail. It will be mentioned that the present disclosure provides that the system and method illustrated by reference to FIG. 1B and FIG. 1C may be incorporated into the system and method illustrated by reference to FIG. 2. In other words, the units 20 and 70 shown in FIG. 2 may work together as illustrated in FIG. 1B, and/or the units 30 and 50 shown in FIG. 2 may work together as illustrated in FIG. 1C. In FIG. 3, which omits unit 70 but retains unit 50, the present disclosure provides an embodiment wherein the features of FIG. 1C are incorporated into the system and method illustrated in FIG. 3, such that redistribution reactor 50 provides a feedstock to distillation column 30.

An embodiment of the process and system of the present disclosure is illustrated in FIG. 2 with reference to FIG. 1B and FIG. 1C. The process and system illustrated in FIG. 2 has three distillation columns, two redistribution reactors on the TCS recycle loop, but only a single redistribution reactor on the DCS recycle loop. In FIG. 2, the first distillation column 20 receives stream 1 via conduit 11 from a source 10, the stream 1 comprising DCS, TCS and STC. The source 10 will be discussed later herein, but may be, for example, an off gas from a hydrogenation reactor that produces unrefined TCS. First distillation column 20 forms and provides relatively high boiling stream 2 which comprises STC, and relatively low boiling stream 3 which comprises DCS and TCS. Stream 2 exits column 20 via conduit 21, while stream 3 exits column 20 via conduit 22. The STC in stream 2 may be recycled to a hydrogenation reactor (which is sometimes referred to in the art as a hydrochlorination reactor) in the front end of the plant, as discussed later herein.

The embodiment of FIG. 2 also comprises a second distillation column 30. The column 30 receives two streams, identified in FIG. 2 as stream 4 and stream 9. Stream 4 comprises DCS, TCS and STC, and enters distillation column 30 via conduit 71. Stream 9 comprises MCS, DCS and TCS, and enters column 30 via conduit 41. In addition, second distillation column 30 generates two streams, identified in FIG. 2 as stream 5 and stream 7. Stream 5 comprises relatively high boiling TCS and STC, and exits column 30 via conduit 31. Stream 7 comprises relatively low boiling silane, MCS and DCS, and exits column 30 via conduit 32.

The embodiment of FIG. 2 comprises a third distillation column 40. The column 40 receives a stream 8 via conduit 61, where stream 8 comprises silane, MCS, DCS and TCS. Column 40 generates two streams, namely stream 9 and stream 10. Stream 9 comprises relatively high boiling MCS, DCS and TCS, while stream 10 comprises relatively low boiling and highly pure silane. Stream 9 exits column 40 via conduit 41, while stream 10 exits column 40 via conduit 42.

In addition to the three distillation columns 20, 30 and 40, the embodiment of FIG. 2 comprises three redistribution reactors 50, 60 and 70. The units 20, 30, 50 and 70 and/or streams S3, S4, S5 and S6 in FIG. 2 comprise what will be referred to as the TCS recycle loop. The units 30, 40 and 60 and/or streams S7, S8 and S9 comprise what will be referred to as the DCS recycle loop.

As used herein, a redistribution reactor receives a feedstock stream and converts that feedstock into an effluent stream according to the following three equilibrium reactions.

2SiHCl₃(TCS) [symbol] SiH₂Cl₂(DCS)+SiCl₄(STC)

2SiH₂Cl₂(DCS) [symbol] SiHCl₃(TCS)+SiH₃Cl(MCS)

2SiH₃Cl(MCS) [symbol] SiH₂Cl₂(DCS)+SiH₄(Silane)

In FIG. 2, the TCS recycle loop comprises two redistribution reactors that receive TCS, and these will be referred to as the first TCS-RR 50 and the second TCS-RR 70. In the TCS recycle loop, stream 3 comprising DCS and TCS from the distillation column 20 is introduced into the second TCS-RR 70. TCS-RR 70 converts a portion of the TCS in stream 3 into DCS and STC, thereby generating stream 4 which comprises DCS, TCS, and STC, where the DCS and STC content in stream 4 are greater than that introduced into TCS-RR 70 via stream 3 and the TCS content is lower than that introduced into TCS-RR 70 via stream 3. Stream 4 exits TCS-RR 70 via conduit 71. Stream 4 is then introduced into distillation column 30 as discussed previously, and stream 5 exits distillation column 30 via conduit 31. The contents of stream 5 enter the first TCS-RR 50. TCS-RR 50 converts a portion of the TCS in stream 5 into DCS and STC, thereby generating stream 6 which comprises DCS, TCS, and STC, where the DCS and STC content in stream 6 are greater than that introduced into TCS-RR 50 via stream 5 and the TCS content is lower than that introduced into TCS-RR 50 via steam 5. Stream 6 exits TCS-RR 70 via conduit 51. Stream 6 is introduced into distillation column 20, where stream 6 is separated into relatively high boiling stream 2 comprising STC and relatively low boiling stream 3 comprising DCS and TCS.

The DCS recycle loop of the embodiment illustrated in FIG. 2 contains a single redistribution reactor that receives DCS, where this DCS-RR will be referred to as the first DCS-RR 60. In the DCS recycle loop, stream 7 comprising silane, MCS and DCS from the distillation column 30 is introduced into the first DCS-RR 60 via conduit 32. DCS-RR 60 converts a portion of the DCS in stream 7 into silane and TCS, thereby generating stream 8 which comprises silane, MCS, DCS, and TCS, where the silane and TCS content in stream 8 are greater than that introduced into DCS-RR 60 via steam 7 and the DCS content is lower than that introduced into DCS-RR 60 via stream 7. Stream 8 exits DCS-RR 60 via conduit 61. Stream 8 is introduced into the third distillation column 40 to generate a stream 9 comprising MCS, DCS and TCS, and a stream 10 comprising largely pure silane. The stream 9 is directed via conduit 41 to the second distillation column 30 to generate streams 5 and 7. In contrast to the embodiment illustrated in FIG. 1A, stream 9 does not enter a second DCS-RR, and in fact the embodiment of FIG. 2 contains only a single DCS-RR on the DCS recycle loop.

In the process and system of the present disclosure represented by FIG. 2, there are a total of three redistribution reactors. The first TCS-RR 50 is located on the bottoms stream 5 leaving the second distillation column 30 and the first DCS-RR 60 is located on the overhead stream 7 leaving the top of the second distillation column 30. The third reactor, named the second TCS-RR 70, is located on the feed to the second distillation column 30 from the first distillation column 20. Thus, in the process configuration of the present disclosure illustrated in FIG. 2, there is a redistribution reactor (1) on the overhead stream 3 exiting the column 20 via conduit 22 to the second distillation column 30, (2) on the bottoms stream 5 exiting the column 30 via conduit 31 to the first distillation column 20, and (3) on the overhead stream 7 exiting the column 30 via conduit 32 to the third distillation column 40. Compared to a comparable process lacking the second TCS-RR 70, the configuration of FIG. 2 increases TCS to DCS conversion per pass around the TCS recycle loop by about 37%, resulting in about 25% less TCS recycle around the TCS recycle loop (a.k.a., low pressure/medium pressure columns loop).

The systems and process of the present disclosure provide that a portion of the product from a redistribution reactor is introduced into the distillation column that provided the feedstock for the redistribution reactor. This feature is not explicitly shown in FIG. 2, however it may be understood by reference to FIG. 2 in combination with FIG. 1B and FIG. 1C, and is described as follows: In one embodiment, a portion of stream 4 is introduced into distillation column 20. Optionally, stream 4 provides the reflux to the top of the distillation column 20. Optionally, stream 4 provides an additional feedstock to the distillation column 20. In another embodiment, a portion of stream 6 is introduced into distillation column 30.

In another embodiment, a portion of stream 8 from redistribution reactor 60 is introduced into distillation column 30. Optionally, stream 8 provides the reflux to the top of the distillation column 30. Optionally, stream 8 provides an additional feedstock to the distillation column 30. The introduction of a portion of stream 8 from redistribution reactor 60 into distillation column 30 may be accomplished in analogy to the method and system illustrated in FIG. 1B, wherein a portion of stream 4 from redistribution reactor 70 is introduced into distillation column 20 as a feedstock only, as a reflux only, or as both a feedstock and a reflux to the distillation column 20.

Thus, it will be mentioned again that the present disclosure provides that the system and method illustrated by reference to FIG. 1B and FIG. 1C may be incorporated into the system and method illustrated by reference to FIG. 2. In other words, the units 20 and 70 shown in FIG. 2 may work together as illustrated in FIG. 1B, and/or the units 30 and 50 shown in FIG. 2 may work together as illustrated in FIG. 1C. For example, in one embodiment the present disclosure provides the system and method illustrated by reference to FIG. 2 which incorporates the features of FIG. 1B but not the features of FIG. 1C. In another embodiment, the present disclosure provides the system and method illustrated by reference to FIG. 2 which incorporates the feature of FIG. 1C but not the features of FIG. 1B. In another embodiment, the present disclosure provides the system and method illustrated by reference to FIG. 2 which incorporates the features of FIG. 1B and the features of FIG. 1C. In each of these embodiments which incorporates the features of FIG. 1B, it is optionally provided that i) the system and method of the present disclosure includes diverter valve 72 but not diverter valve 74 such that some portion of stream 4 is used as reflux to the distillation column 20 but no portion of stream 4 is used as additional feedstock to distillation column 20; ii) the system and method of the present disclosure includes diverter valve 74 but not diverter valve 72 such that some portion of stream 4 is used as additional feedstock to the distillation column 20 but no portion of stream 4 is used as the reflux for distillation column 20; and iii) the system and method of the present disclosure includes diverter valve 74 and also includes diverter valve 72 such that some portion of stream 4 is used as additional feedstock to the distillation column 20 and some portion of stream 4 is used as the reflux for distillation column 20.

In the system and process illustrated in FIG. 2 with reference also to FIG. 1B and FIG. 1C, the following optional embodiments may be included.
As an optional embodiment, the first distillation column 20 exit stream 2 may be cooled before being fed into the second TSC-RR 70. The requirement for cooling medium (e.g., cooling water) and adverse effect on second distillation column 30 reboiler duty is minimal because approximately 80% of the cooling load can be recovered with a process to process exchanger.
A variation of this modification is where the feed to the new reactor 70 is pressurized and the product exiting the new reactor 70 is flashed in distillation column 30, where reactor 70 is new relative to the traditional UCC process.

Another embodiment of the process and system of the present disclosure is illustrated in FIG. 3 with reference to FIG. 1C. The process and system illustrated in FIG. 3 has three distillation columns, two redistribution reactors on the DCS recycle loop, but only one redistribution reactor on the TCS recycle loop. In FIG. 3, the first distillation column 20 receives stream 1 via conduit 11 from a source 10, the stream 1 comprising DCS, TCS and STC. The source 10 will be discussed later herein, but may be, for example, an off gas from a hydrogenation reactor that produces unrefined TCS. First distillation column 20 forms and provides relatively high boiling stream 2 which comprises STC, and relatively low boiling stream 3 which comprises DCS and TCS. Stream 2 exits column 20 via conduit 21, while stream 3 exits column 20 via conduit 22. The STC in stream 2 may be recycled to a hydrogenation reactor in the front end of the plant, as discussed later herein.

The embodiment of FIG. 3 also comprises a second distillation column 30. The column 30 receives two streams, identified in FIG. 3 as stream 3 and stream 11. Stream 3 comprises DCS and TCS, and enters distillation column 30 via conduit 22. Stream 11 comprises silane, MCS, DCS and TCS, and enters column 30 via conduit 81. In addition, second distillation column 30 generates two streams, identified in FIG. 3 as stream 5 and stream 7. Stream 5 comprises relatively high boiling TCS and STC, and exits column 30 via conduit 31. Stream 7 comprises relatively low boiling silane, MCS and DCS, and exits column 30 via conduit 32.

The embodiment of FIG. 3 comprises a third distillation column 40. The column 40 receives a stream 8 via conduit 61, where stream 8 comprises silane, MCS, DCS and TCS. Column 40 generates two streams, namely stream 9 and stream 10. Stream 9 comprises relatively high boiling MCS, DCS and TCS, while stream 10 comprises relatively low boiling but highly pure silane. Stream 9 exits column 40 via conduit 41, while stream 10 exits column 40 via conduit 42.

In addition to the three distillation columns 20, 30 and 40, the embodiment of FIG. 3 comprises three redistribution reactors 50, 60 and 80. The units 20, 30 and 50 and/or the streams S3, S5 and S6 in FIG. 3 comprise what will be referred to as the TCS recycle loop. The units 30, 40, 60 and 80 and/or streams S7, S8, S9 and S11 comprise what will be referred to as the DCS recycle loop.

As used herein, a redistribution reactor receives a feedstock stream and converts that feedstock into an effluent stream according to the following three equilibrium reactions.

2SiHCl₃(TCS) [symbol] SiH₂Cl₂(DCS)+SiCl₄(STC)

2SiH₂Cl₂(DCS) [symbol] SiHCl₃(TCS)+SiH₃Cl(MCS)

2SiH₃Cl(MCS) [symbol] SiH₂Cl₂(DCS)+SiH₄(Silane)

The TCS recycle loop of the embodiment illustrated in FIG. 3 comprises a single redistribution reactor that receives TCS, and this will be referred to as the first TCS-RR 50. In the TCS recycle loop, stream 3 comprising DCS and TCS from the distillation column 20 is introduced to the second distillation column 30 without passing through a redistribution reactor. Streams 5 and 7 are generated by and exit distillation column 30 via conduits 31 and 32, respectively. The contents of stream 5 enter the first TCS-RR 50. TCS-RR 50 converts a portion of the TCS in stream 5 into DCS and STC, thereby generating stream 6 which comprises DCS, TCS, and STC, where the DCS and STC content in stream 6 are greater than that introduced into TCS-RR 50 via steam 5 and the TCS content is lower than that introduced into TCS-RR 50 via steam 5. Stream 6 exits TCS-RR 50 via conduit 51. Stream 6 is introduced to distillation column 20, where it is separated into relatively high boiling stream 2 comprising STC and relatively low boiling stream 3 comprising DCS and TCS.

In FIG. 3, the DCS recycle loop comprises two redistribution reactors that receive DCS, and these will be referred to as the first DCS-RR 60 and the second DCS-RR 80. In the DCS recycle loop, stream 7 comprising silane, MCS and DCS from the distillation column 30 is introduced via conduit 32 to the first DCS-RR 60. DCS-RR 60 converts a portion of the DCS in stream 7 into silane and TCS, thereby generating stream 8 which comprises silane, MCS, DCS, and TCS, where the silane and TCS content in stream 8 are greater than that introduced into DCS-RR 60 via steam 7 and the DCS content is lower than that introduced into DCS-RR 60 via stream 7. Stream 8 exits DCS-RR 60 via conduit 61. Stream 8 is introduced into the third distillation column 40 to generate a stream 9 comprising MCS, DCS and TCS, and a stream 10 comprising largely pure silane. The stream 9 is directed via conduit 41 to a second DCS-RR 80, which converts the mixture of MCS, DCS and TCS in stream 9 to a mixture of silane, MCS, DCS and TCS which exits the second DCS-RR 80 via conduit 81 as stream 11. Stream 11 is introduced into the second distillation column 30 as discussed above, to generate streams 5 and 7.

The systems and process of the present disclosure provide that a portion of the product from a redistribution reactor is introduced into the distillation column that provided the feedstock for the redistribution reactor. This feature is not explicitly shown in FIG. 3, however it may be understood by reference to FIG. 3 in combination with FIG. 1C, and the discussion provided herein. In one embodiment, a portion of stream 6 is introduced into distillation column 30, as shown in FIG. 1C. In another embodiment, a portion of stream 8 is taken from redistribution reactor 60 and is introduced into distillation column 30. Optionally, stream 8 provides the reflux to the top of the distillation column 30. Optionally, stream 8 provides an additional feedstock to the distillation column 30. The introduction of stream 8 from redistribution reactor 60 into distillation column 30 may be accomplished in analogy to the system and method illustrated in FIG. 1B for stream 4 from redistribution reactor 70 into distillation column 20, respectively.

Thus, it will be mentioned again that the present disclosure provides that the system and method illustrated by reference to FIG. 1C may be incorporated into the system and method illustrated by reference to FIG. 3. In other words, the units 30 and 50 shown in FIG. 3 may work together as illustrated in FIG. 1C. In addition, or alternatively, and by analogy to FIG. 18 and FIG. 1C, the present disclosure also provides embodiments wherein a portion of stream 8 is introduced into distillation column 30. Optionally, stream 8 provides the reflux to the top of the distillation column 30. Optionally, stream 8 provides an additional feedstock to the distillation column 30. In another embodiment, a portion of stream 11 from redistribution reactor 80 is introduced into distillation column 40, where this may be accomplished in analogy to the system and method illustrated in FIG. 1C wherein a portion of stream 6 from redistribution reactor 50 is introduced in distillation column 30, respectively. These embodiments may be practiced separately or in any combination.

The present disclosure provides systems and processes that include at least three redistribution reactors in a system and process for silane manufacture, where at least two of those redistribution reactors operate in series in a recycle loop. The system and process of the present disclosure may be utilized in a plant that manufactures polysilicon from silane. Such a plant may be based on the well-known and widely-practiced UCC process, to which according to the present disclosure a second TCS-RR and/or a second DCS-RR is added to a TCS recycle loop and/or a DCS recycle loop, respectively, as explained herein.

In operation, the first, second and third distillation columns may operate at the same, or at different, pressures. The first distillation column should operate under conditions that provide for the separation of STC from DCS/TCS. The second distillation column should operate under conditions that provide for the separation of TCS/STC from silane/MCS/DCS. The third distillation column should operate under conditions that provide for the separation of silane from MCS/CDS/TCS. In each case, separation need not be complete separation, but should be at least partial separation. For example, the first distillation column 20 may operate at relatively low pressure, the second distillation column 30 may operate at a pressure greater than the operating pressure of the first distillation column 20, and the third distillation column 40 may operate at a pressure greater than the operating pressure of the second distillation column 30. To reflect this incremental increase in operating pressure between the first (20), second (30) and third (40) distillation columns, those three columns may alternatively be referred to as the low pressure, medium pressure and high pressure columns, respectively.

FIG. 4 is provided to illustrate two points. The first point is to provide a reference system and process for comparison with the system and process of the present disclosure. This point will be discussed later herein. The second point, to be discussed at this time, is to provide an exemplary system and process for providing stream 1 to the system and process of the present disclosure, and/or for utilizing stream 10 of the present system and process. The systems and processes of the present disclosure, which are illustrated in FIGS. 1-3 as supplemented by FIG. 1B and FIG. 1C, receive a stream 1 that contains a mixture of DCS, TCS and STC. Such a mixture may be produced by a polysilicon producing plant, part of such a plant being illustrated in FIG. 4.

In FIG. 4, a conduit 85 delivers off gas, or a fraction or refinement thereof, from a polysilicon producing reactor, for example, a chemical vapor deposition (CVD) reactor or a fluidized bed reactor (FBR). The conduit 85 meets a conduit 86 at a mixing value 87, to provide a chemical stream that travels from mixing valve 87 through conduit 88 to hydrogenation reactor 93. Also entering hydrogenation reactor 93 is a supply of metallurgic silicon, which travels through conduit 94. STC, which may come from distillation unit 20 through conduit 21, mixing valve 23 and then conduit 95, may also be delivered to the hydrogenation reactor 93. Also entering mixing valve 23 is a make-up STC stream traveling through conduit 96. The product produced by the hydrogenation reactor 93 exits the reactor through conduit 92 and then enters a quenching chamber 89. Optional feed to reactor 93 includes, in various embodiments, one of, or two of, or three of, or all of: hydrogen chloride (HCl), silane, DCS, and TCS. The quenching chamber 89 generates three streams: a stream comprising hydrogen which exits through conduit 86; a stream comprising hydrogen, DCS, TCS and STC which exits through conduit 90, and a stream comprising heavy boiling materials which is delivered to a waste treatment facility through conduit 91. The stream exiting through conduit 86 is combined with the stream in conduit 85 at the mixing valve 87 as discussed above. The stream in conduit 90 is introduced into a light ends stripper 10, which is an optional source of stream 1 in the systems and processes of the present disclosure. Conduit 12 delivers light boiling impurities, such as unwanted nitrogen, methane, and hydrogen, from light stripper 10 to a waste treatment facility, where said facility may include component separation and recovery processes.

In addition, FIG. 4 shows a column 97 which receives silane from third distillation unit 40 via conduit 42. Exiting column 97 is conduit 98 that delivers hydrogen to waste treatment, and conduit 99 which delivers silane to a storage tank 100.

FIG. 4 shows a reference TCS recycle loop comprising first distillation column 20, stream S3, second distillation column 30, stream S5, first TCS-RR 50 and stream S6. The TCS recycle loop illustrated in FIGS. 1A and 2 as supplemented by the disclosure provided herein by reference to FIG. 1B and/or FIG. 1C, which includes a second TCS-RR 70, may be substituted for the TCS recycle loop of FIG. 4 to provide another embodiment of the present disclosure. FIG. 4 also shows a reference DCS recycle loop comprising second distillation column 30, stream S7, first DCS-RR 60, stream 8, third distillation column 40, and stream S9. In another embodiment of the present disclosure, the DCS recycle loop illustrated in FIGS. 1A and 3, as supplemented by the disclosure provided herein by reference to FIG. 1B and/or FIG. 1C, which includes a second DCS-RR 80, may be substituted for the DCS recycle loop of FIG. 4. To provide yet another embodiment of the present disclosure, each of the TCS recycle loop illustrated in FIGS. 1A and 2 and the DCS recycle loop illustrated in FIGS. 1A and 3, each as supplemented by the disclosure provided herein by reference to FIG. 1B and/or FIG. 1C, may be substituted for the TCS recycle loop and DCS recycle loop, respectively, of FIG. 4.

The systems and process of the present disclosure provide that a portion of the product from a redistribution reactor is introduced into the distillation column that provided the feedstock for the redistribution reactor. This feature is not explicitly shown in FIG. 4, however may be understood by reference to FIG. 4 in combination with FIG. 1B and FIG. 1C, and is described as follows: In one embodiment, a portion of stream 6 is introduced into distillation column 30. In another embodiment, a portion of stream 8 is introduced into distillation column 30. Optionally, stream 8 provides the reflux to the top of the distillation column 30. Optionally, stream 8 provides an additional feedstock to the distillation column 30.

Accordingly, in one embodiment, the front end of a system and process illustrated in FIG. 4 as supplemented by FIG. 1B and/or FIG. 1C may be used to provide a source of stream 1. Such an optional front end system and process comprises a hydrogenation reactor (a.k.a. hydrochlorination reactor) 93 which converts metallurgic silicon, silicon tetrachloride (STC/SiCl₄) and hydrogen to TCS; a quench system 89 which separates hydrogen recycle and waste high boilers from crude TCS; and a distillation column 10 which separates light impurities from the crude TCS stream. The hydrogenation reactor 93 receives metallurgical grade silicon (MGSi), chlorosilanes including one or more of DCS, TCS and STC, and hydrogen. One source of STC for the hydrogenation reactor may be stream S2.

The incorporation of two redistribution reactors on either one or both of the TCS recycle loop and the DCS recycle loop, in combination with the recycle of some effluent from a redistribution reactor to the distillation column which provided the feedstock to the redistribution reactor, as illustrated in FIG. 1B and FIG. 1C, provides significant benefits. These benefits will be illustrated in the following discussion and Tables.

In Table 2, comparison data is provided for two cases of the systems and methods of FIGS. 1-4 which include redistribution reactor 70 but do not have redistribution reactor 80. In the first case (A), with traditional reflux but with no incorporation of any of the recycle events which are disclosed by reference to FIG. 1B or FIG. 1C (hereinafter for descriptive purposes referred to as “Baseline”). In the second case (B) there is no traditional reflux but there is incorporation of the recycle event disclosed by reference to FIG. 1B as stream 14 and as applied only to distillation column 20 and redistribution reactor 70 (hereinafter for descriptive purposes referred to as “Recycle”). In Table 2, each of the two cases A and B are compared to the system and methods of FIG. 4 that does not include an additional redistribution reactor 70 or 80 (which is the basic UCC process, which may be referred to herein as the legacy process, or as “Legacy”).

Thus, as shown in Table 2, and as compared to the UCC (Legacy) process, the Baseline process (see FIG. 2) which includes a redistribution reactor 70, provides a reduced flow of material through each of streams 4, 5 and 6, by 24% (where streams 4, 5 and 6 may be said to constitute the TCS Recycle Loop). In other words, the TCS Recycle Loop in the Legacy process is 24% larger than it is in the Baseline process. When the recycle approach of FIG. 1B is incorporated into the system and method of FIG. 2 but with only stream 14 between redistribution reactor 70 and distillation column 20 and no traditional reflux (i.e., the “Recycle” case), the flow is changed to further reduce the amounts of streams 4, 5 and 6, achieving a total reduction of 44% to 45% in the TCS Recycle Loop. In addition, the amount of traditional reflux to the distillation column 20 (stream 12) in the Baseline case (FIG. 2 and as defined above) is reduced by 19% compared to the Legacy UCC process when redistribution reactor 70 is added to the Legacy UCC system. The amount of reflux to column 20 is further slightly reduced compared to the Legacy UCC process when the recycle system of FIG. 1B (stream 14 in FIG. 1A in the Recycle case) is incorporated into the system of FIG. 2, assuming ¾ of stream 4 becomes stream 14, and ¼ of stream 4 is fed to distillation column 30 in FIG. 1B.

Also shown in Table 2 is that there is some change in the composition of the streams 3, 4, 5 and 6 when the Legacy UCC process is modified to add a redistribution reactor 70 (that is to say, the “Baseline” case as defined above), and there is further change in the composition of streams 3, 4, 5 and 6 when the recycle system of FIG. 1B is incorporated into the system and method of FIGS. 1A or 2-4 (that is to say, the “Recycle” case as defined above). In Table 2, “N/A” means not applicable. Table 2 shows that the reduction in TCS Recycle Loop flow is made possible by the significant increase in DCS concentration in stream 4 (28% higher in the Baseline case and 60% higher in the Recycle case compared to the UCC or Legacy process).

TABLE 2

| Stream | | | |
|---|---|---|---|
| # | Component | Baseline | Recycle |
| 4 | Flow | −25% | −44% |
| 5 | Flow | −25% | −45% |
| 6 | Flow | −25% | −45% |
| 12 | Flow | −19% | N/A |
| 14 | Flow | N/A | −21% |
| 3 | MCS Mole Composition | −60% | 143% |
| | DCS Mole Composition | −32% | 41% |
| | TCS Mole Composition | 2% | −9% |
| | STC Mole Composition | 196% | 630% |
| 4 | MCS Mole Composition | 90% | 205% |
| | DCS Mole Composition | 28% | 60% |
| | TCS Mole Composition | −13% | −15% |
| | STC Mole Composition | 1584% | 1193% |
| 5 | MCS Mole Composition | 19% | 288% |
| | DCS Mole Composition | 30% | 42% |
| | TCS Mole Composition | −9% | −7% |
| | STC Mole Composition | 1351% | 1014% |
| 6 | MCS Mole Composition | −52% | −41% |
| | DCS Mole Composition | −31% | −23% |
| | TCS Mole Composition | −1% | −1% |
| | STC Mole Composition | 41% | 29% |

Table 3 illustrates a benefit of incorporating the recycle system of FIG. 1B into the system of FIG. 2 (see column labeled “Recycle”, where the Recycle case is as defined above) vs. the system of FIG. 2 without incorporation of the recycle system of FIG. 1B (see column labeled “Baseline”, where the Baseline case is as defined above) where in both cases the comparison is made to the Legacy UCC process. The Recycle case in Table 3 assumes the situation where 75% of the effluent from the redistribution reactor 70 (stream 4) is directed back to the distillation column 20 as reflux (stream 14), i.e., 75% of stream 4 is diverted to become stream 14 and with no traditional reflux. A system that incorporates the features illustrated in FIG. 1B results in an energy savings for each of the energies required to run the units 20, 30 and 40. For example, the energy required to power the reboiler function of the distillation column 20 is reduced by 10% upon incorporation of the recycle system of FIG. 1B (which uses 35% less energy than the legacy UCC process for this operation) into the baseline system of FIG. 1A (i.e., the “Baseline” case which, by itself, achieves a 25% energy savings compared to the legacy UCC process for this operation). In other words, the recycle system of FIG. 1B achieves an additional 10% (35% minus 25%) energy savings in distillation column 20 reboiler energy consumption compared to the system of FIG. 1A without incorporation therein of the system of FIG. 1B.

TABLE 3

| | | % Change from Legacy | | |
|---|---|---|---|---|
| | | UCC Process | | |
| | | | | Optimized |
| Block # | Component | Baseline | Recycle | Recycle* |
| 20 | Reboiler Energy | −25% | −35% | −40% |
| 20 | Condenser Energy | −21% | −26% | −31% |
| 30 | Reboiler Energy | −17% | −27% | −28% |
| 30 | Condenser Energy | −16% | −24% | −24% |
| 40 | Reboiler Energy | −6% | −9% | −8% |
| 40 | Condenser Energy | −1% | −1% | −1% |
| 20 + 30 + 40 | Total Reboiler Energy | −21% | −31% | −35% |
| 20 + 30 + 40 | Total Condenser Energy | −19% | −25% | −28% |

*“Optimized Recycle” results from optimized column design and operational columns efficiencies to distillation 20, 30, and 40 in the modified UCC process of the presence disclosure.

The energy savings illustrated in Table 3 are dependent on the amount of stream 4 that is diverted to become reflux stream 14 and then sent to distillation column 20. This dependence is shown in Tables 4 and 5. In each of Tables 4 and 5, comparisons are made between the system and methods of FIG. 2 that includes the recycle system of FIG. 1B (that is the Recycle case as defined above), vs. the Legacy UCC process which does not include either of the recycle systems of FIG. 1B or the additional redistribution reactor 70. In Table 4, the flow rates and compositions of the various streams are described as a function of the percentage of S4 that is diverted to S14 so that, e.g., 75% Diversion means that 75% of the flow in stream 4 is diverted to become reflux stream 14 while 25% of stream 4 is fed to distillation column 30. In Table 5, the corresponding energy savings are provided for the systems and compositions described in Table 4. In Tables 3 and 5, for example, a change of −35% means that a value that was formerly, e.g., 10 kw-hr/kg product becomes 6.5 kw-hr/kg product.

TABLE 4

| | | Recycle Case % Change | | | |
|---|---|---|---|---|---|
| | | from Legacy UCC Process | | | |
| Stream | | 55% | 65% | 75% | 80% |
| # | Component | Diversion | Diversion | Diversion | Diversion |
| 3 | Flow | 120% | 117% | 122% | 141% |
| 4 | Flow | −1% | −24% | −44% | −52% |
| 5 | Flow | −1% | −24% | −45% | −52% |
| 6 | Flow | −1% | −24% | −45% | −52% |
| 14* | Flow | −43% | −33% | −21% | −9% |
| 3 | MCS Mole Composition | −20% | 34% | 143% | 220% |
| | DCS Mole Composition | −16% | 7% | 41% | 60% |
| | TCS Mole Composition | −8% | −8% | −9% | −11% |
| | STC Mole Composition | 1696% | 1154% | 630% | 471% |
| 4 | MCS Mole Composition | 15% | 80% | 205% | 284% |
| | DCS Mole Composition | 0% | 25% | 60% | 78% |
| | TCS Mole Composition | −12% | −13% | −15% | −17% |
| | STC Mole Composition | 2124% | 1654% | 1193% | 1017% |
| 5 | MCS Mole Composition | 143% | 229% | 288% | 288% |
| | DCS Mole Composition | −14% | 9% | 42% | 60% |
| | TCS Mole Composition | −11% | −9% | −7% | −6% |
| | STC Mole Composition | 1732% | 1370% | 1014% | 879% |
| 6 | MCS Mole Composition | −62% | −53% | −41% | −35% |
| | DCS Mole Composition | −39% | −32% | −23% | −20% |
| | TCS Mole Composition | −3% | −2% | −1% | −1% |
| | STC Mole Composition | 56% | 42% | 29% | 23% |

*Reduction in flow compared to Stream 12 in the Legacy UCC process. There is no stream 12 in the Recycle case; a 43% reduction with 55% diversion means that if the recycle rate in stream 12 in the Legacy case was 100 moles reflux/unit time, then the Recycle case with 55% diversion is only 57 moles reflux per the same unit of time.

TABLE 5
Recycle Case % Change from Legacy UCC Process

| | | 55% | 65% | 75% | 80% |
|---|---|---|---|---|---|
| Block # | Component | Diversion | Diversion | Diversion | Diversion |
| 20 | Reboiler Energy | −36% | −37% | −35% | −28% |
| 20 | Condenser Energy | −29% | −29% | −26% | −19% |
| 30 | Reboiler Energy | 3% | −15% | −27% | −30% |
| 30 | Condenser Energy | −24% | −24% | −24% | −24% |
| 40 | Reboiler Energy | −3% | −5% | −9% | −10% |
| 40 | Condenser Energy | −1% | −1% | −1% | −1% |
| 20 + 30 + 40 | Total Reboiler Energy | −20% | −28% | −31% | −28% |
| 20 + 30 + 40 | Total Condenser Energy | −27% | −27% | −25% | −20% |

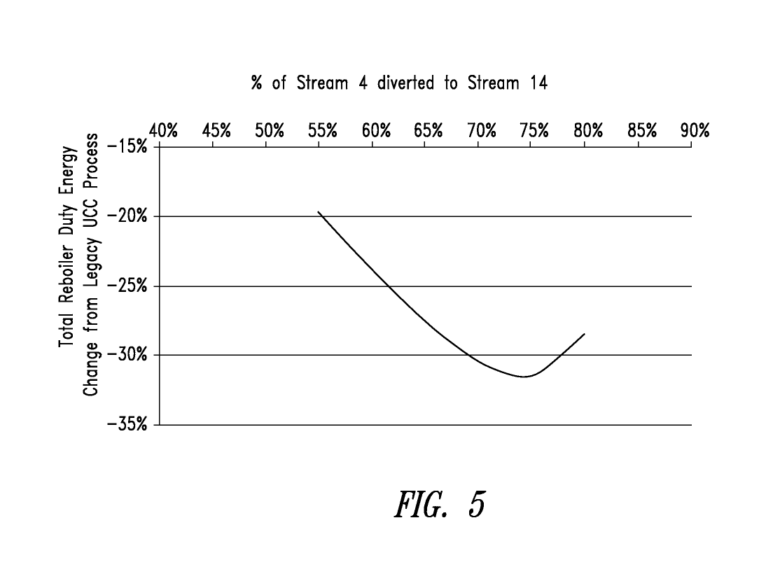

The data in Tables 2-5 clearly demonstrate the energy savings afforded by including a recycle system according to FIG. 1B in a modified UCC process (modified to include one or more additional redistribution reactors). This energy savings is shown graphically in FIG. 5. FIG. 5 shows that when about 70 to 75% of the effluent from a redistribution reactor is recycled back to the distillation column that produced the feedstock for the redistribution reactor, then an approximately optimum operating condition results for a system and method of the present disclosure that incorporates a recycle system of FIG. 1B into a modified UCC process as shown in, e.g., FIG. 1A, FIG. 2 or FIG. 4. When the recycle system of FIG. 1B is incorporated into a process as shown in, e.g., FIG. 1A, FIG. 2 or FIG. 4, the operation of the distillation columns 20, 30 and 40 may be optimized using techniques known to the person of ordinary skill in the art, in order to realize even greater energy savings.

The following are some exemplary embodiments of the present disclosure.
A system for silane production comprising:
   a. a first distillation column (20) in fluid communication with
      i. a first TCS redistribution reactor (50) and
      ii. a second TCS redistribution reactor (70);
   b. a second distillation column (30) in fluid communication with
      i. the first TCS redistribution reactor (50);
      ii. the second TCS redistribution reactor (70);
      iii. a third distillation column (40); and
      iv. a first DCS redistribution reactor (60);
   c. the third distillation column (40) in fluid communication with
      i. the first DCS redistribution reactor (60); and
      ii. the second distillation column (30);
   d. and one or more conduits selected from:
      i. conduit whereby a portion of an effluent from the first TCS redistribution reactor (50) is directed back into the second distillation column (30);
      ii. conduit whereby a portion of an effluent from the second TCS redistribution reactor (70) is directed back into the first distillation column (20); and
      iii. conduit whereby a portion of an effluent from the first DCS redistribution reactor (60) is directed back into the second distillation column (30);
   where the first distillation column (20) provides a feedstock for the second TCS redistribution reactor (70) and the second distillation column (30) provides a feedstock for each of the first TCS redistribution reactor (50) and the first DCS redistribution reactor (60).
A system for silane production comprising:
   e. a first distillation column (20) in fluid communication with
      i. a first TCS redistribution reactor (50); and
      ii. a second distillation column (30);
   f. the second distillation column (30) in fluid communication with
      i. the first TCS redistribution reactor (50);
      ii. the first distillation column (20);
      iii. a first DCS redistribution reactor (60); and
      iv. a second DCS redistribution reactor (80);
   g. a third distillation column (40) in fluid communication with
      i. the first DCS redistribution reactor (60); and
      ii. the second DCS redistribution reactor (80);
   h. and one or more conduits selected from
      i. conduit whereby a portion of an effluent from the first TCS redistribution reactor (50) is directed back into the second distillation column (30);
      ii. conduit whereby a portion of an effluent from the second DCS redistribution reactor (80) is directed back into the third distillation column (40); and
      iii. conduit whereby a portion of an effluent from the first DCS redistribution reactor (60) is directed back into the second distillation column (30).
   where the second distillation column (30) provides a feedstock for the first TCS redistribution reactor (50) and the first DCS redistribution reactor (60), and the third distillation column (40) provides a feedstock for the second DCS redistribution reactor (80).

In connection with the foregoing exemplary embodiments, it will be mentioned that when conduit is provided whereby a portion of an effluent from a redistribution reactor is directed back into a distillation column, it should be understood that the effluent is unchanged in composition between leaving the redistribution reactor and entering the distillation column. For instance, the effluent is not subjected to a distillation process after it exits the redistribution reactor and before it enters the distillation column.

As mentioned previously, any of the various embodiments described above can be combined to provide further embodiments. Aspects of the embodiments can be modified, if necessary to employ concepts of the various patents, applications and publications to provide yet further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

What is claimed is:

1. A process comprising:
a) recovering a fraction from a distillation column;
b) subjecting the fraction, which will be referred to as the nondistributed fraction, to a redistribution reaction to thereby convert the nondistributed fraction to a redistributed fraction; and then
c) returning a portion of the redistributed fraction to the distillation column.

2. The process of claim 1 wherein the redistribution reaction comprises at least one of:
a) trichlorosilane [symbol] dichlorosilane and silicon tetrachloride;
b) dichlorosilane [symbol] trichlorosilane and monochlorosilane; and
c) monochlorosilane [symbol] dichlorosilane and silane.

3. The process of claims 1-2 wherein the redistributed fraction comprises more dichlorosilane than does the nondistributed fraction.

4. The process of claims 1-2 wherein the redistributed fraction comprises more trichlorosilane than does the nondistributed fraction.

5. The process of claims 1-4 wherein the distillation column separates silicon tetrachloride from trichlorosilane.

6. The process of claims 1-4 wherein the distillation column separates trichlorosilane from dichlorosilane.

7. The process of claims 1-4 wherein the distillation column separates dichlorosilane from silane.

8. The process of claims 1-7 wherein 20-80 wt % of the redistributed fraction is returned to the distillation column.

9. The process of claims 1-8 further comprising introducing another portion of the redistributed fraction into an additional distillation column.

10. The process of claims 1-9 wherein the portion of the redistributed fraction provides a reflux to the distillation column.

11. The process of claims 1-10 further comprising converting silane (SiH₄) to polysilicon.

12. A system comprising:
a) a distillation column;
b) a redistribution reactor;
c) a conduit that directs a fraction from the distillation column into the redistribution reactor; and
d) a conduit that directs a portion of a product from the redistribution reactor back into the distillation column.

13. The system of claim 12 further comprising another distillation column.

14. The system of claims 12-13 further comprising another redistribution reactor.

15. The system of claims 12-14 further comprising a reactor to convert SiH₄ to polysilicon.
